(19) United States
(12) Patent Application Publication
(10) Pub. No.: US 2024/0380250 A1
(43) Pub. Date: Nov. 14, 2024

(54) WIRELESS CHARGING SYSTEM WITH A SPLIT TRANSMITTER AND A SPLIT RECEIVER

(71) Applicant: The Hong Kong Polytechnic University, Hong Kong (CN)

(72) Inventors: Ka Wai Eric CHENG, Hong Kong (CN); Jinhong SUN, Hong Kong (CN); Heshou WANG, Hong Kong (CN)

(21) Appl. No.: 18/691,922

(22) PCT Filed: Sep. 13, 2022
(86) PCT No.: PCT/CN2022/118426

§ 371 Date: Mar. 14, 2024

Related U.S. Application Data
(60) Provisional application No. 63/261,209, filed on Sep. 15, 2021.

(51) Int. Cl. H02J 50/40; H01F 27/28; H01F 38/14; H02J 50/12

(52) U.S. Cl. CPC H02J 50/402; H01F 27/28; H01F 38/14; H02J 50/12

(57) ABSTRACT

A wireless charging system for providing multi-frequency and multi-speed charging modes to transfer power wirelessly from a base device to a remote device is disclosed. The wireless charging system includes a split transmitter having a plurality of sub-transmitters; a split receiver having a plurality of sub-receiver; and a switched-capacitor circuitry comprising a plurality of switched-capacitor switches. The plurality of sub-receivers and the plurality of sub-transmitters each comprises co-planar induction coils of non-equal cross-sectional lengths positioned concentrically without an interception. The split transmitter and the switched-capacitor circuitry are controlled by a hybrid pulse width modulation (PWM) control method, and the split receiver is controlled by a model predictive control method.

### CROSS-REFERENCE TO RELATED APPLICATIONS

This application claims the benefit of the U.S. Provisional Patent Application No. 63/261,209, filed on 15 Sep. 2021, which is incorporated by reference herein in its entirety.

### FIELD OF THE INVENTION

The present disclosure is generally related to wireless power transfer. Particularly, the present disclosure is related to systems and methods with a split transmitter and a split receiver for providing multi-frequency and multi-speed charging modes to transfer power wirelessly to a remote device, such as an electric vehicle having one or more batteries.

### BACKGROUND OF THE INVENTION

Electric vehicles have become increasingly popular as an emerging means of public transportation. However, the shortcomings of electric vehicles such as weak endurance and inconvenient charging greatly limit their applied area. The development of wireless charging technology can enable electric vehicles to carry a smaller number of battery packs, extend their cruising range, and make electrical energy supply safer and more convenient.

Conventionally, a two-coil wireless power transfer system comprises one transmitter (Tx) 10 and one receiver (Rx) 20, as illustrated in FIG. 1, which is not suitable for different expected charging objectives since it can only generate one-level output. Therefore, the conventional wireless charging circuit scheme can only offer one output charging speed with a fixed charging frequency. An exemplary circuit diagram for a conventional two-coil wireless power transfer system is shown in FIG. 2.

However, installing more electric vehicle charging structures may give rise to some safety hazards to the power grid, especially during the peak period of urban electricity consumption. On the premise of keeping the impact on the grid to a minimum, it is necessary to optimize the matching of the charging speed of electric vehicles and the charging standards in different time periods. The charging standard should be divided into at least two types, one is a standard for peak electricity consumption and the rest are collectively referred to as normal periods.

Accordingly, there is a need in the art to have a safer and multiple-output wireless charging system for electric vehicles. More preferably, the design should ensure the stability of the power grid under the premise of saving energy and money. Furthermore, other desirable features and characteristics will become apparent from the subsequent detailed description and the appended claims, taken in conjunction with the accompanying drawings and this background of the disclosure.

### SUMMARY OF THE INVENTION

Provided herein is a wireless charging system for providing multi-frequency and multi-speed charging modes to transfer power wirelessly from a base device to a remote device. The wireless charging system includes a split transmitter having a plurality of sub-transmitters; a split receiver having a plurality of sub-receiver; and a switched-capacitor circuitry comprising a plurality of switched-capacitor switches. The plurality of sub-receivers and the plurality of sub-transmitters each comprises co-planar induction coils of non-equal cross-sectional lengths positioned concentrically without an interception. The split transmitter and the switched-capacitor circuitry are controlled by a hybrid pulse width modulation (PWM) control method, and the split receiver is controlled by a model predictive control method for adaptively adjusting an output current level and a charging speed based on a status of the power grid.

In accordance with a further embodiment of the present disclosure, the switched-capacitor circuitry is configured to construct a resonant circuit for charging an output load by selecting working states of the plurality of switched-capacitor switches.

In accordance with a further embodiment of the present disclosure, the wireless charging system further includes a switch-state control unit configured to receive or detect a time period of a peak electricity consumption and a target frequency for optimizing charging performance of the wireless charging system by controlling plural switches in the split transmitter, the split receiver, and the switched-capacitor circuitry.

In accordance with a further embodiment of the present disclosure, an individual sub-transmitter of the plurality of sub-transmitters comprises a transmitter capacitor and a transmitter induction coil, thereby the plurality of sub-transmitters realize series resonant compensation networks.

In accordance with a further embodiment of the present disclosure, the plurality of sub-transmitters are arranged in parallel and comprise a plurality of transmitter switches controllable by the switch-state control unit for selecting one or more transmitter induction coils to enable.

In accordance with a further embodiment of the present disclosure, an individual sub-receiver of the plurality of sub-receivers comprises a receiver capacitor and a receiver induction coil for defining the output current level and the charging speed.

In accordance with a further embodiment of the present disclosure, the plurality of sub-receiver are arranged in series and comprise a plurality of receiver switches controllable by the switch-state control unit for selecting one or more receiver induction coils to enable.

In accordance with a further embodiment of the present disclosure, the model predictive control method determines a charging standard based on the time period of the peak electricity consumption, wherein the charging standard is selected from a slow charging mode, a normal charging mode, and a fast charging mode.

In accordance with a further embodiment of the present disclosure, the wireless charging system further includes an inverter at the base device. The inverter comprises a plurality of switching elements, and wherein the plurality of switching elements is a field-effect transistor such as an insulated-gate bipolar transistor (IGBT), a metal-oxide-semiconductor field-effect transistor (MOSFET), or other semiconductor devices.

In accordance with a further embodiment of the present disclosure, the plurality of sub-transmitters and the plurality of sub-receivers have a circular structure, a rectangular structure, or a triangular structure.

In accordance with another embodiment of the present disclosure, a wireless charging system for providing charging modes of plural charging frequencies and plural charging speeds is provided. The wireless charging system includes a transmitter having a transmitter coil arrangement; and a receiver having a receiver coil arrangement. The transmitter coil arrangement, the receiver coil arrangement, or both the transmitter coil arrangement and the receiver coil arrangement have multiple induction coils for providing the charging modes with an adjustable charging frequency and an adjustable charging speed. The multiple induction coils are co-planar coils concentrically arranged.

In accordance with a further embodiment of the present disclosure, the transmitter comprises a plurality of sub-transmitters arranged in parallel. An individual sub-transmitter of the plurality of sub-transmitters comprises a transmitter capacitor and a transmitter induction coil for realizing series resonant compensation networks.

In accordance with a further embodiment of the present disclosure, the receiver comprises a plurality of sub-receivers arranged in series. An individual sub-receiver of the plurality of sub-receivers comprises a receiver capacitor and a receiver induction coil for defining an output current level and a charging speed.

In accordance with another embodiment of the present disclosure, a method of wirelessly transmitting power is provided. The method includes the steps of selecting a number of sub-transmitters to be enabled and choosing a suitable resonant circuit of a switched-capacitor circuitry for charging an output load using a hybrid PWM control method; and determining a time period of a peak electricity consumption for adaptively adjusting an output current level and a charging speed using a model predictive control method; generating a magnetic field via a split transmitter having a plurality of sub-transmitters in response to receiving an electrical current from a power source; and receiving the magnetic field via a split receiver having a plurality of sub-receiver placed above the split transmitter. The plurality of sub-receivers and the plurality of sub-transmitters each comprises co-planar induction coils of non-equal cross-sectional lengths positioned concentrically without an interception.

In accordance with a further embodiment of the present disclosure, the method further includes the step of determining a charging standard selected from a slow charging mode, a normal charging mode, and a fast charging mode for achieving smart-grid integration. The charging standard is changed to the slow charging mode at the time period of the peak electricity consumption.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects and advantages of the present invention are disclosed as illustrated by the embodiments hereinafter.

### BRIEF DESCRIPTION OF THE DRAWINGS

The appended drawings contain figures to further illustrate and clarify the above and other aspects, advantages, and features of the present disclosure. It will be appreciated that these drawings depict only certain embodiments of the present disclosure and are not intended to limit its scope. It will also be appreciated that these drawings are illustrated for simplicity and clarity and have not necessarily been depicted to scale. The present disclosure will now be described and explained with additional specificity and detail through the use of the accompanying drawings in which:

FIG. 1 depicts a conventional two-coil wireless power transfer system comprising one Tx and one Rx;

FIG. 2 depicts an exemplary circuit diagram for the conventional two-coil wireless power transfer system of FIG. 1;

FIG. 3 depicts a first wireless charging system with a circular N induction coil structure for both Tx and Rx, in accordance with certain embodiments of the present disclosure;

FIG. 4 depicts a second wireless charging system with a rectangular N induction coil structure for both Tx and Rx, in accordance with certain embodiments of the present disclosure;

FIG. 5 depicts a third wireless charging system with a triangular N induction coil structure for both Tx and Rx, in accordance with certain embodiments of the present disclosure;

FIG. 6 depicts a wireless charging system with 3 sub-transmitters and 3 sub-receivers, in accordance with certain embodiments of the present disclosure;

FIG. 7 depicts a wireless charging system with 3 sub-transmitters and only 1 sub-receiver, in accordance with certain embodiments of the present disclosure;

FIG. 8 depicts a wireless charging system with only 1 sub-transmitter and 3 sub-receivers, in accordance with certain embodiments of the present disclosure;

FIG. 9 depicts a block diagram conceptually illustrating the charging of a remote device using the wireless charging systems of FIGS. 3-8;

FIG. 10 depicts an overview block diagram of the wireless charging system, in accordance with certain embodiments of the present disclosure;

FIG. 11 depicts a schematic diagram of the inverter and the split transmitter of the wireless charging system;

FIG. 12 depicts a schematic diagram of the split receiver, the power rectifier, and the switched-capacitor circuitry of the wireless charging system; and

FIG. 13 depicts a flow chart illustrating the method of wirelessly transmitting power using the wireless charging system, in accordance with certain embodiments of the present disclosure.

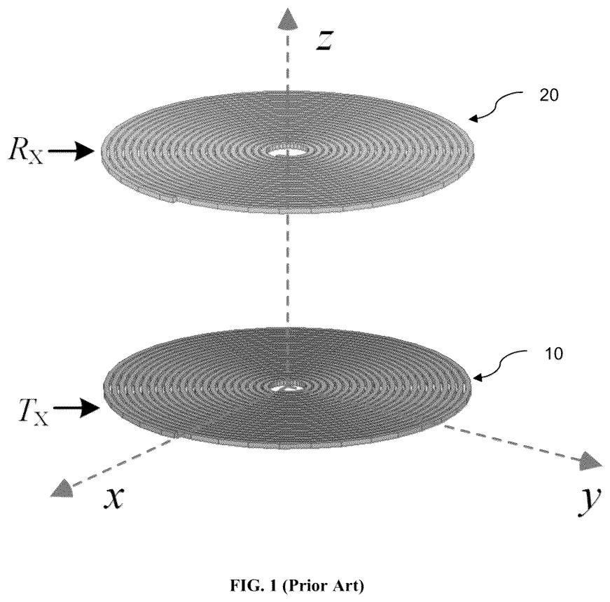

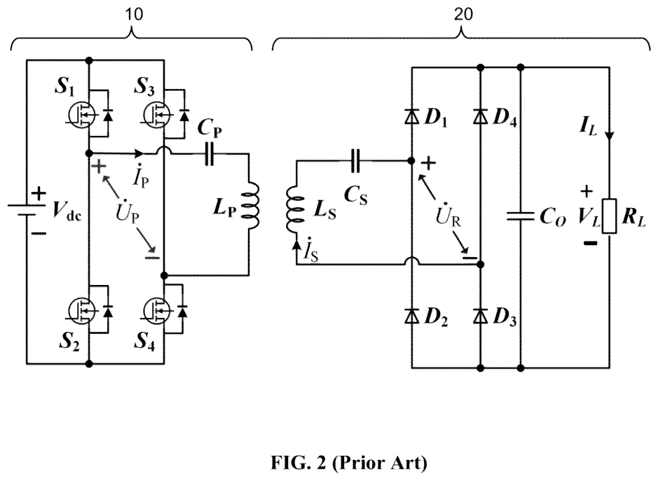

### DETAILED DESCRIPTION OF THE INVENTION

The following detailed description is merely exemplary in nature and is not intended to limit the disclosure or its application and/or uses. It should be appreciated that a vast number of variations exist. The detailed description will enable those of ordinary skilled in the art to implement an exemplary embodiment of the present disclosure without undue experimentation, and it is understood that various changes or modifications may be made in the function and structure described in the exemplary embodiment without departing from the scope of the present disclosure as set forth in the appended claims.

The benefits, advantages, solutions to problems, and any element(s) that may cause any benefit, advantage, or solution to occur or become more pronounced are not to be construed as a critical, required, or essential features or elements of any or all of the claims. The invention is defined solely by the appended claims including any amendments made during the pendency of this application and all equivalents of those claims as issued.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The terms “comprising,” “having,” and “including” or any other variation thereof, are to be construed as open-ended terms (i.e., meaning “including, but not limited to,”) unless otherwise noted. The use of any and all examples, or exemplary language (e.g., “such as”) provided herein, is intended merely to illuminate the invention better and does not pose a limitation on the scope of the invention unless otherwise claimed. No language in the specification should be construed as indicating any non-claimed element as essential to the practice of the invention. Further, unless expressly stated to the contrary, “or” refers to an inclusive “or” and not to an exclusive “or”. For example, a condition A or B is satisfied by any one of the following: A is true and B is false, A is false and B is true, and both A and B are true. Terms of approximation, such as “about”, “generally”, “approximately”, and “substantially” include values within ten percent greater or less than the stated value.

Unless otherwise defined, all terms (including technical and scientific terms) used in the embodiments of the present invention have the same meaning as commonly understood by an ordinary skilled person in the art to which the present invention belongs.

As used herein, the term “cross-sectional length” is used to refer to the diameter of a circular cross-sectional area or the width of a polygonal cross-sectional area.

As used herein, the terms “transmitter,” “receiver,” “primary,” and “secondary” and the like are used to refer to the transmission of electrical energy from a transmitting device to a receiving device. However, the energy transmission may occasionally be performed in an opposite direction, for example, with a small amount, for enhancing the alignment of the transmitter and receiver or achieving other communication purposes. In such cases, the “transmitter” may be configured to receive energy and the “receiver” may be configured to transmit energy.

The term “wirelessly charging” or the like refers to transferring any form of energy associated with electric fields, magnetic fields, electromagnetic fields, or otherwise from a transmitter to a receiver without any physical electrical conductors. The power output into a wireless field (e.g., a magnetic field) may be received, captured, or coupled by an induction coil at the receiver to achieve power transfer. It will be understood that two components being “coupled” may refer to the interaction through direct or indirect ways, and may refer to a physically connected (e.g., wired) coupling or a physically disconnected (e.g., wireless) coupling.

The described structure can have any suitable components or characteristics that allow the structure to perform multi-frequency and multi-speed wirelessly charging of a battery. In order to achieve the objective, a multiple-Tx and a multiple-Rx intelligent combination design has been proposed to provide more optimal choices of the wireless charging patterns based on the real-time requirements between the power grid and the customer. According to the peak value period generated by the feedback of the power grid, the charging standard can be divided into at least two types, one is a standard for a peak electricity consumption and the rest are collectively referred to as normal periods. In the preferred application, the structure is used for charging an electric vehicle. In other alternative embodiments, the structure can have any suitable designs that allow the structure to be used for charging other battery packs in other electrically powered devices, such as drones, mobile phones, wearable devices, notebook computers, and the like.

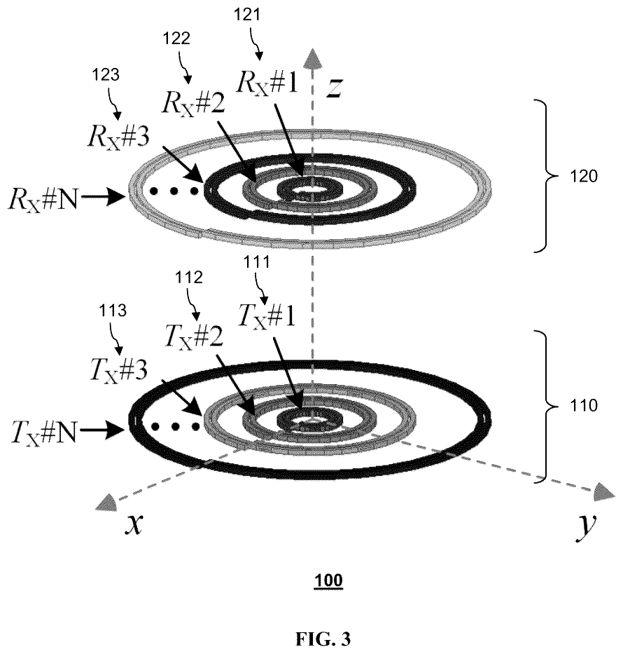

In order to achieve the above-stated advantages, one embodiment of the present disclosure provides a first wireless charging system 100 with a circular N induction coil structure. In particular, the first wireless charging system 100 includes a split transmitter 110 having a plurality of circular and coplanar sub-transmitters concentrically arranged on the primary side (base device); and a split receiver 120 having a plurality of circular sub-receivers concentrically arranged on the secondary side (remote device), as illustrated in FIG. 3. The split transmitter 110 is not a single coil transmitter, while the split receiver 120 is not a single coil receiver. The split transmitter 110 is formed by plural sub-transmission coils in a circular structure, indicated as Tx #1 111, Tx #2 112, Tx #3 113, . . . , Tx #N. Unlike the conventional structure, the single coil transmitter is divided into N number of sub-transmitters in the present disclosure. Similarly, the split receiver 120 is formed by plural sub-receiver coils in a circular structure, indicated as Rx #1 121, Rx #2 122, Rx #3 123, . . . , Rx #N. Unlike the conventional structure, the single coil receiver is divided into N number of sub-receivers in the present disclosure. With the system having plural sub-transmission coils and plural sub-receiver coils, the system can realize charging processes of different frequencies and speeds.

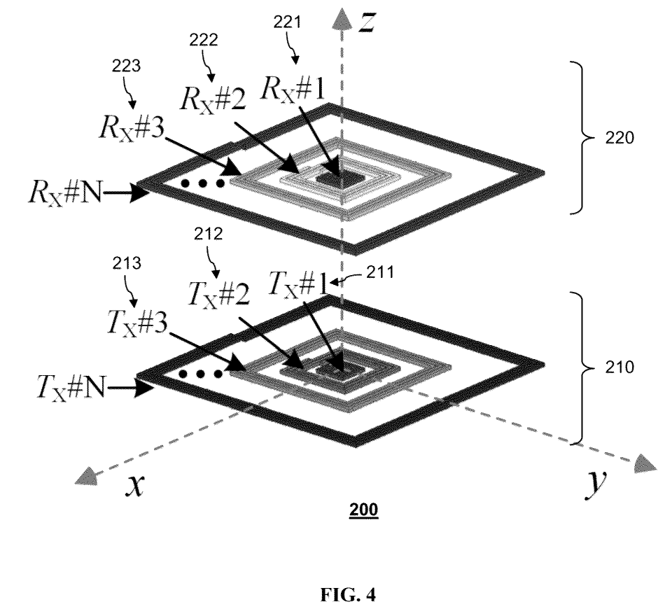

Another embodiment of the present disclosure provides a second wireless charging system 200 with a rectangular N induction coil structure. In particular, the first wireless charging system 100 includes a split transmitter 210 having a plurality of rectangular and coplanar sub-transmitters concentrically arranged; and a split receiver 220 having a plurality of rectangular sub-receivers concentrically arranged, as illustrated in FIG. 4. The split transmitter 210 is not a single coil transmitter, while the split receiver 220 is not a single coil receiver. The split transmitter 210 is formed by plural sub-transmission coils in a rectangular structure, indicated as Tx #1 211, Tx #2 212, Tx #3 213, . . . , Tx #N. Unlike the conventional structure, the single coil transmitter is divided into N number of sub-transmitters in the present disclosure. Similarly, the split receiver 220 is formed by plural sub-receiver coils in a rectangular structure, indicated as Rx #1 221, Rx #2 222, Rx #3 223, . . . , Rx #N. Unlike the conventional structure, the single coil receiver is divided into N number of sub-receivers in the present disclosure. With the system having plural sub-transmission coils and plural sub-receiver coils, the system can realize charging processes of different frequencies and speeds.

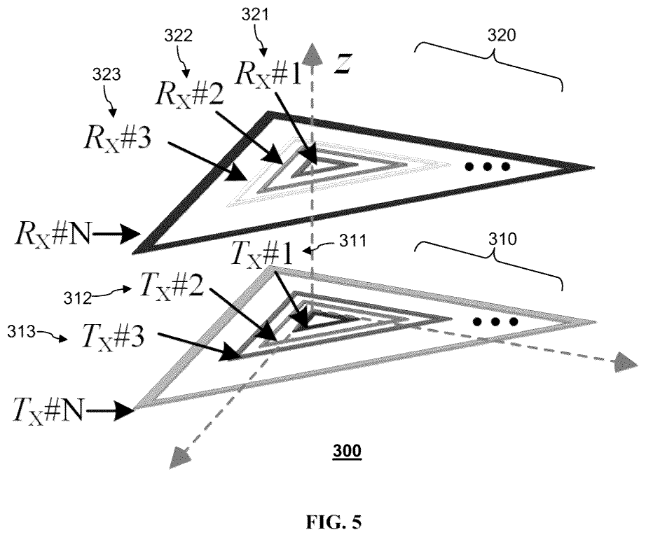

A further embodiment of the present disclosure provides a third wireless charging system 300 with a triangular N induction coil structure. In particular, the first wireless charging system 100 includes a split transmitter 310 having a plurality of triangular and coplanar sub-transmitters concentrically arranged; and a split receiver 320 having a plurality of triangular sub-receivers concentrically arranged, as illustrated in FIG. 5. The split transmitter 310 is not a single coil transmitter, while the split receiver 320 is not a single coil receiver. The split transmitter 310 is formed by plural sub-transmission coils in a triangular structure, indicated as Tx #1 311, Tx #2 312, Tx #3 313, . . . , Tx #N. Unlike the conventional structure, the single coil transmitter is divided into N number of sub-transmitters in the present disclosure. Similarly, the split receiver 320 is formed by plural sub-receiver coils in a triangular structure, indicated as Rx #1 321, Rx #2 322, Rx #3 323, . . . , Rx #N. Unlike the conventional structure, the single coil receiver is divided into N number of sub-receivers in the present disclosure. With the system having plural sub-transmission coils and plural sub-receiver coils, the system can realize charging processes of different frequencies and speeds.

FIGS. 3-5 provides the three different structures of the induction coils of both Tx and Rx. It is apparent that the shapes of the induction coils illustrated are simple exemplary designs and may be otherwise. The multiple induction coils are co-planar coils concentrically arranged and formed from a material of high magnetic permeability, such as ferrite. For example, the multiple induction coils of the Tx and Rx may have the shape of a square, a rhombus, a pentagon, a hexagon, a heptagon, an octagon, an oval, a star, or a clover, etc., without departing from the scope and spirit of the present disclosure.

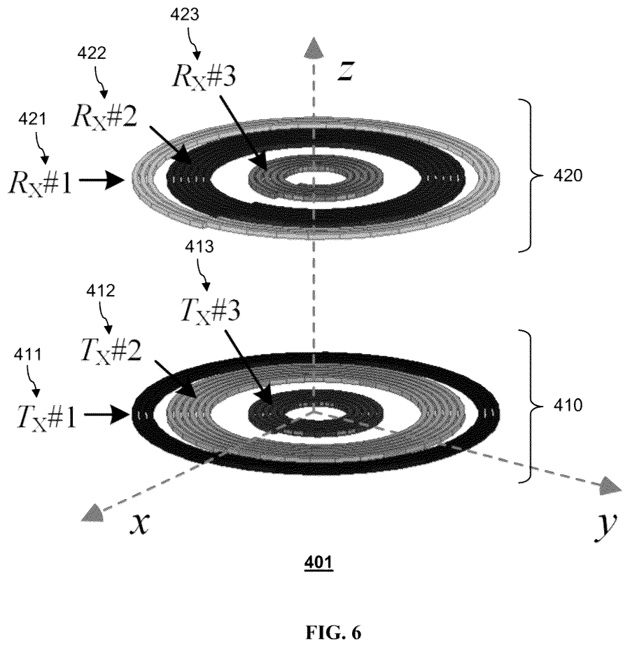

Further embodiments of the present disclosure are illustrated in FIGS. 6-8 based on a wireless charging system with three circular coils on Tx, Rx, or both. The number of coils and the shape of the coils are selected for simplicity and convenience. Various other alternative designs of the wireless charging system may employ the same inventive concepts to realize charging processes of different frequencies and speeds. The transmitter 410, 430 has a transmitter coil arrangement, and the receiver 420, 440 has a receiver coil arrangement. The transmitter coil arrangement, the receiver coil arrangement, or both the transmitter coil arrangement and the receiver coil arrangement have multiple induction coils arranged concentrically, which can provide the charging modes with an adjustable charging frequency and an adjustable charging speed. The multiple induction coils are co-planar coils concentrically arranged on a plane defined by the X-axis and Y-axis. The transmitter 410, 430 and the receiver 420, 440 are in parallel to each other and are vertically aligned. If the transmitter 410, 430 and the receiver 420, 440 are not well aligned centrally, there may be a low rate of power transfer than that could be achieved.

FIG. 6 provides a wireless charging system 401 similar to the first wireless charging system 100, which includes a split transmitter 410 having three sub-transmitters 411-413; and a split receiver 420 having three sub-receivers 421-423. The three sub-transmitters 411-413 are arranged concentrically, wherein the first sub-transmitter 411 has the smallest radius, which is surrounded by the second sub-transmitter 412, and further surrounded by the third sub-transmitter 413 with the largest radius. Similarly, the three sub-receivers 421-423 are arranged concentrically, wherein the first sub-receiver 421 has the smallest radius, which is surrounded by the second sub-receiver 422, and further surrounded by the third sub-transmitter 423 with the largest radius. It is not necessary for the split transmitter 410 and the split receiver 420 to be symmetrical with respect to each other. The sub-transmitters 411-413 of the split transmitter 410 are co-planar induction coils of non-equal transmitter radii (cross-sectional lengths) positioned concentrically without an interception. The sub-receivers 421-423 of the split receiver 420 are also co-planar induction coils of non-equal receiver radii (cross-sectional lengths) positioned concentrically without an interception. The split receiver 420 is preferably placed centrally above the split transmitter 410, yet not necessarily be aligned precisely. The split receiver 420 is configured to receive power from the vertical component (Z-axis) of the magnetic field induced from the split transmitter 410.

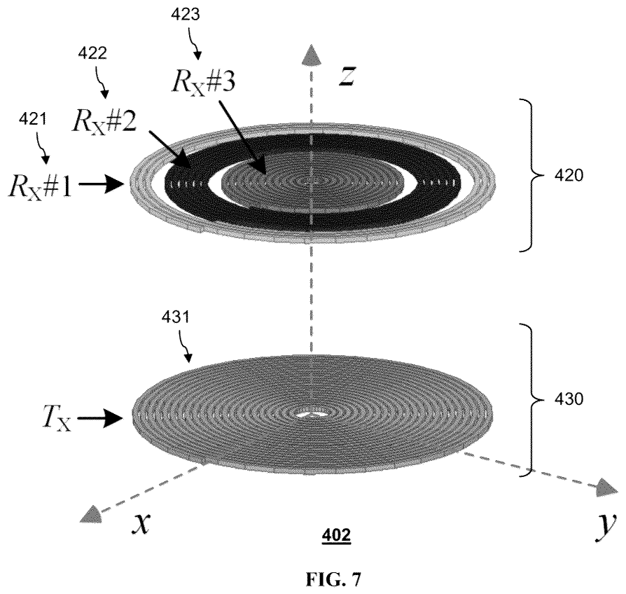

FIG. 7 provides another wireless charging system 402 similar to the first wireless charging system 100, which includes a transmitter 430 having a single sub-transmitter 431; and a split receiver 420 having three sub-receivers 421-423. The single sub-transmitter 431 is analogous to the conventional transmitter with one fixed charging frequency and charging speed. The three sub-receivers 421-423 are arranged concentrically.

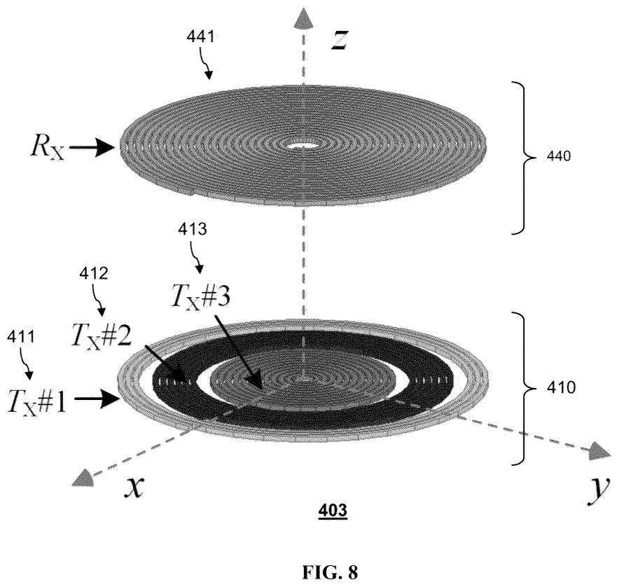

FIG. 8 provides another wireless charging system 403 similar to the first wireless charging system 100, which includes a split transmitter 410 having three sub-transmitters 411-413;

and a receiver 440 having a single sub-receiver 441. The three sub-transmitters 411-413 are arranged concentrically. The single sub-receiver 441 is analogous to the conventional receiver with one fixed charging frequency and charging speed.

Based on the above disclosure and the conceptual illustration of FIG. 9, one embodiment of the present disclosure provides a wireless charging system 500 for wirelessly transmitting power from a base device 502 (or sometimes referred to as a “power pad”) to a remote device 503. The base device 502 is the primary structure capable of efficiently coupling energy to the remote device 503. The remote device 503 is the secondary structure capable of receiving energy from the base device 502. Electric power is provided from a power supply or the power grid to a power distribution infrastructure 501 for generating a field for providing the energy transfer from the base device 502 to the remote device 503. The power distribution infrastructure 501 may be configured to supply electric power to one or more base devices 502. The remote device 503 is an electrically powered device, such as an electric vehicle, a drone, an electric boat, or the like. Using an electric vehicle as an exemplary illustration, the power distribution infrastructure 501 is installed in a car park and connected to the power grid for providing energy transfer to a plurality of electric vehicles. The electric vehicle can be parked in a designated parking space having the base device 502 appropriately positioned for charging the batteries in the electric vehicle.

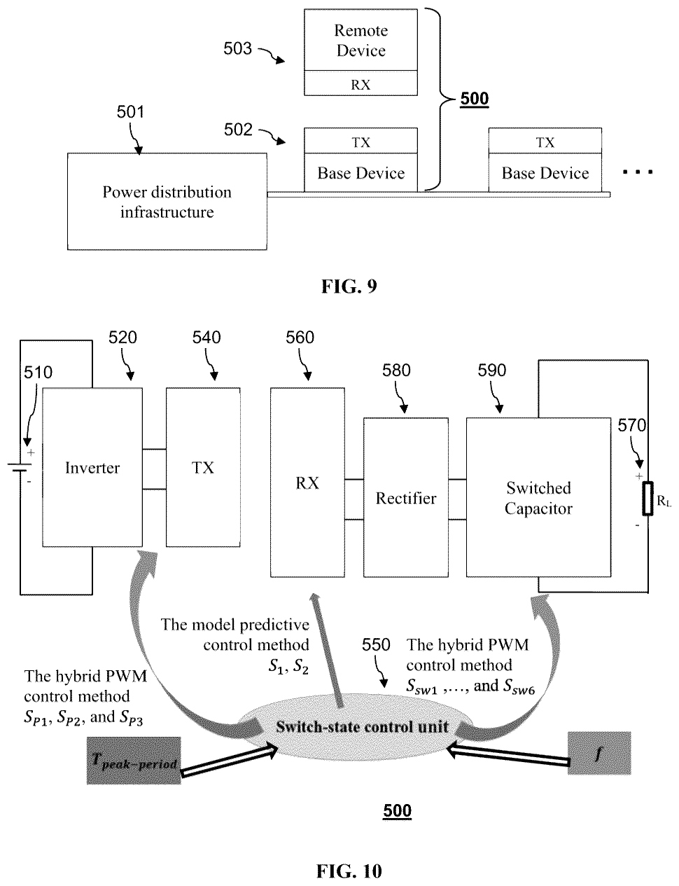

In further detail, as shown in FIG. 10, the wireless charging system 500 comprises an inverter 520 and a split transmitter 540 at the base device 502, and a split receiver 560, a power rectifier 580, and a switched-capacitor circuitry 590 at the remote device 503. The split transmitter 540 includes a plurality of sub-transmitters, and the split receiver 560 includes a plurality of sub-receivers. The power source 510, which may be AC power or DC power, is supplied to the inverter 520. The output of the inverter 520 is connected to the split transmitter 540 for transferring energy to the split receiver 560 of the remote device 503. The received power is coupled to the power rectifier 580 and the switched-capacitor circuitry 590 for charging the output load 570, which may be one or more batteries. Advantageously, the wireless charging system 500 comprises a switch-state control unit 550, which is constructed by a model predictive control method for controlling the split receiver 560, and a hybrid pulse width modulation (PWM) control method for controlling the split transmitter 540 and the switched-capacitor circuitry 590. The switch-state control unit 550 receives or detects a peak period (T_{peak-period}) of urban electricity consumption and the frequency to optimize the performance of the wireless charging system 500 by controlling plural switches in the split transmitter 540, the split receiver 560, and the switched-capacitor circuitry 590.

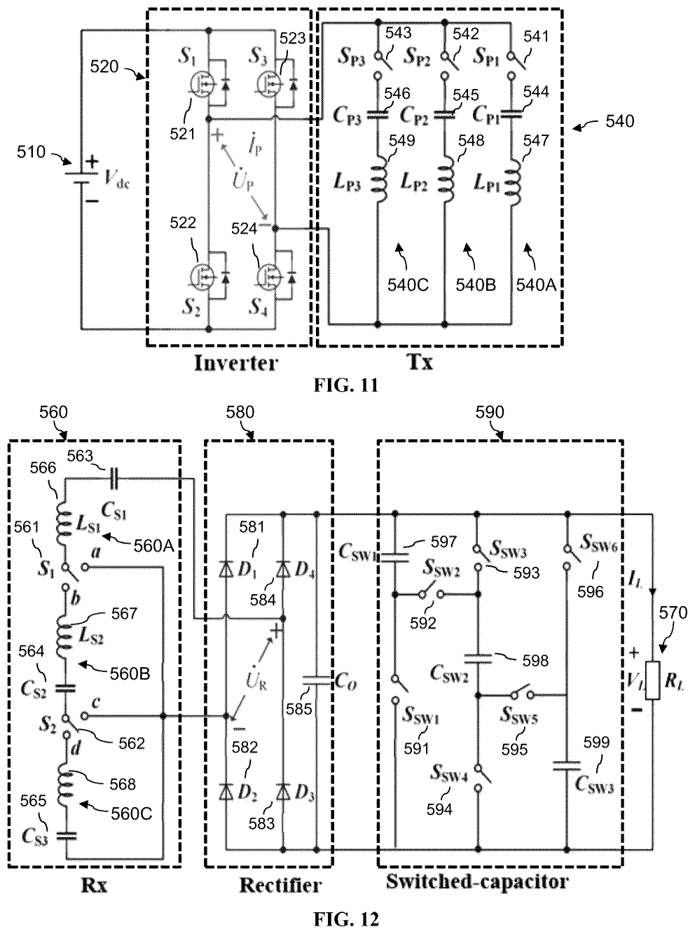

FIG. 11 is a schematic diagram of exemplary components of the inverter 520 and the split transmitter 540 of the wireless charging system. The inverter 520 may be one full-bridge inverter or two half-bridge inverters. An example of the full-bridge inverter is shown in the illustrated embodiment. The full bridge inverter 520 comprises a plurality of switching elements 521-524. The plurality of switching elements 521-524 may be a field-effect transistor such as an insulated-gate bipolar transistor (IGBT), a metal-oxide-semiconductor field-effect transistor (MOSFET), or other semiconductor devices. The output of the inverter 520 is connected to the split transmitter 540.

The schematic diagram of FIG. 11 also shows the circuit for the split transmitter 540 with three sub-transmitters 540A-540C arranged in parallel. The three sub-transmitters 540A-540C may not be identical to each other. An individual sub-transmitter of the plurality of sub-transmitters 540A-540C comprises a transmitter capacitor 544-546 and a transmitter induction coil 547-549, thereby the plurality of sub-transmitters realize series resonant compensation networks. The first sub-transmitter 540A comprises a first switch S_{P1} 541, a first transmitter capacitor 544, and a first transmitter induction coil 547. The second sub-transmitter 540B comprises a second switch S_{P2} 542, a second transmitter capacitor 545, and a second transmitter induction coil 548. The third sub-transmitter 540C comprises a third switch S_{P3} 543, a third transmitter capacitor 546, and a third transmitter induction coil 549. The three switches 541-543 in the split transmitter 540 are responsible for selecting one or more suitable sub-transmitters 540A-540C to enable. The transmitter induction coils 547-549 generate an electromagnetic field for charging the remote device 503. When more of the switches 541-543 are enabled, more transmitter induction coils 547-549 are activated for producing an energy field. The energy field corresponds to the near field of the transmitter induction coils 547-549 with strong reactive fields resulting from the currents across the capacitor and induction coil pair of each sub-transmitters 540A-540C.

FIG. 12 is a schematic diagram of exemplary components of the split receiver 560, the power rectifier 580, and the switched-capacitor circuitry 590 of the wireless charging system. The split receiver 560 comprises three sub-receivers 560A-560C arranged in series. An individual sub-receiver of the plurality of sub-receivers 560A-560C comprises a receiver capacitor 563-565 and a receiver induction coil 566-568 for defining an output current level and a charging speed. The receiver induction coils 566-568 may receive power when the receiver induction coils 566-568 are located in the energy field of the transmitter induction coils 547-549, which may be captured by the receiver induction coils 566-568 to obtain an AC output signal. Preferably, the receiver induction coils 566-568 are placed at a region corresponding to the near field of the transmitter induction coils 547-549 with strong reactive fields. The receiver induction coils 566-568 are connected in series with a plurality of receiver switches S₁, S₂ 561, 562 provided between the receiver induction coils 566-568 for selecting the number of receiver induction coils 566-568 to be activated, for defining an output current level and a charging speed, which can provide an optimal receiver coil. As provided below in Table I, the relationship between the switch states on the remote device 503 and the charging mode selection is demonstrated:

TABLE I
The relationship between closed switches and output levels

| Closed Switches | Output Current Level | Charging mode |
|---|---|---|
| S₁ 561 to a | Level-1 output | Slow charging k = 1 |
| S₁ 561 b and S₂ 562 to c | Level-2 output | Normal charging k = 2 |
| S₁ 561 b and S₂ 562 to d | Level-3 output | Fast charging k = 3 |

The remote device 503 may further comprise a power rectifier 580 and a switched-capacitor circuitry 590 for converting the AC output signal to a DC rectified signal and generating a suitable power output to charge the output load 570. The power rectifier 580 adjusts the induced current from the split receiver 560 to become a stable power. The power rectifier 580 may be a full-wave bridge rectifier including a plurality of diodes 581-584 and a stabilization capacitor 585. It is apparent that the power rectifier 580 may include any other various circuity appropriate for AC-DC rectification, such as half-wave bridge rectifier.

The magnetic resonance plays an important role in wireless power transfer systems. To male resonance circuits, capacitors are adopted to compensate coils. The split receiver contains many coils, thereby requiring different capacitors. The switched-capacitor circuitry 590 is suitable and configured to construct suitable resonant circuits for the split receivers by selecting the combination of states of the switched-capacitor switches S_{SW1}, S_{SW2}, . . . , S_{SW6} 591-596 of the switched-capacitor circuitry 590.

The switch-state control unit 550, which may be a processor or a programmable device, is configured to determine (receive or detect) a time period of a peak electricity consumption and a target frequency to optimize the charging performance of the wireless charging system 500 by controlling plural switches in the split transmitter 540, the split receiver 560, and the switched-capacitor circuitry 590. In certain embodiments, the switch-state control unit 550 is constructed by the model predictive control method and the hybrid PWM control method.

$$[ \begin{matrix}{U}_{P} \\ {U}_{S}\end{matrix} ] = [ \begin{matrix}0 & j ω M \\ j ω M & 0\end{matrix} ] [ \begin{matrix}{I}_{P} \\ {I}_{S}\end{matrix} ] \qquad ( 1 )$$

$${I}_{{S}_{k}} = \frac{{U}_{P}}{{M}_{k}} ( k = 1 , 2 , 3 ) \qquad ( 2 )$$

wherein:
Uₚ is the input voltage at the primary side (base device);
Uₛ is the output voltage at the secondary side (remote device);
Iₚ is the input current at the primary side (base device);
Iₛ is the output current at the secondary side (remote device);
ω is the angular operating frequency (both base device and remote device);
M is the mutual inductance between the transmitter and the receiver (both base device and remote device);
j is the j-operator (both base device and remote device);
Iₛ_{ₖ} is the output current in the k mode (remote device);
Mₖ is the mutual inductance in the k mode (both base device and remote device); and
k is the charging mode shown in Table I.

With the hybrid PWM control method, the split transmitter 540 and the switched-capacitor circuitry 590 are given an appropriate matching value of the resonant capacitors by selecting the combination of states of the switches. Particularly, to achieve the required frequency, the switch-state control unit 550 couples enable signals to S_{P1}, S_{P2}, S_{P3}, and S_{SW1}, S_{SW2}, . . . , S_{SW6} accordingly.

As the input voltage Uₚ is unchanged, the output current at the secondary side depends on the mutual inductance. The model predictive control method is configured to determine the charging standard based on the peak period of urban electricity consumption. For example, the charging standard may be determined by the switch-state control unit 550 or other processors. Particularly, the model predictive control method adaptively adjusts an output current level and a charging speed of the wireless charging device based on a status of the power grid. Therefore, different output currents can be generated, which can achieve at least three different charging standards to meet the demand of smart-grid integration, wherein the charging standard is selected from a slow charging mode, a normal charging mode, and a fast charging mode.

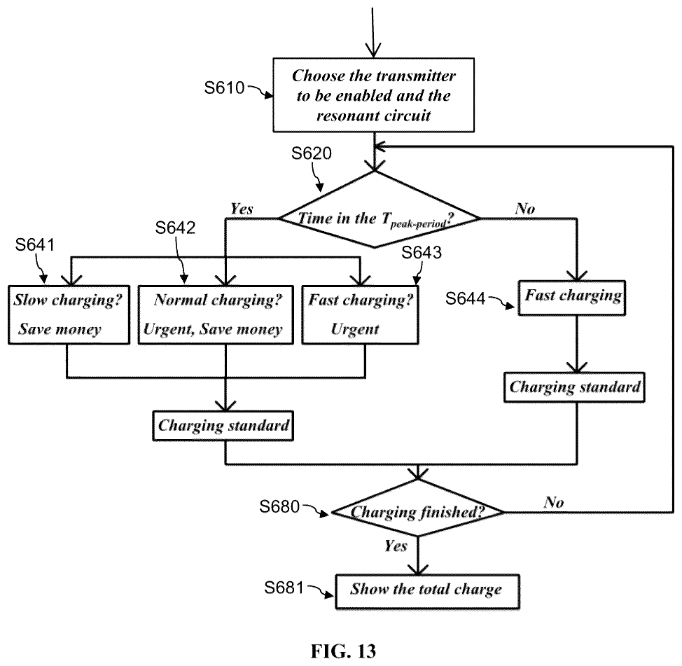

FIG. 13 provides a flow chart illustrating the method of wirelessly transmitting power using the wireless charging system. The first step is to select a number of sub-transmitters to be enabled by selecting the working state of the transmitter switches S_{P1}, S_{P2}, and S_{P3} based on the charging requirement, and to choose a suitable resonant circuit for charging an output load by selecting the working states of the switched-capacitor switches S_{SW1}, S_{SW2}, . . . . S_{SW6} S610. The split transmitter 540 and the switched-capacitor circuitry 590 are controlled using the hybrid PWM control method. According to the signals generated by the feedback of the power grid, the charging standard are different even with the same charging pattern. Therefore, the user can change the charging mode of the electric vehicle based on the charges in the electric vehicle and the required charging time. The second step is to determine the time period of the peak electricity consumption, i.e. peak period (T_{peak-period}) of urban electricity consumption S620. The peak electricity consumption period is not a fixed time period and is generated by the feedback from the power grid. This is based on the model predictive control method for controlling the receiver switches S₁, S₂ 561, 562. If the power grid is in a peak electricity consumption, the user can choose a charging standard based on the slow charging mode S641, the normal charging mode S642, or the fast charging mode S643. When the time period of the peak electricity consumption is passed, the charging standard is changed to the fast charging mode S644. With the adaptive adjustment of the output current level and the charging speed, the user can effectively select different modes based on the status of the power grid. Therefore, the wireless charging system can be optimized by using a slow charging mode S641 to save money during a peak usage period, and using a fast charging mode S644 to save time during an off-peak period. Accordingly, the charging standard can be determined with consideration from the perspective of economical combination, which the model predictive control method is to predict the switch states of S₁ and S₂ 561, 562. Lastly, when the charging is finished S680, the total charges will be calculated and shown to the user S681.

With the wireless charging system of the present disclosure, the system can (1) achieve multiple frequency selection for performing the wireless charging; (2) supply multiple charging modes for the electric vehicles; (3) offer predictive actions for charging mode based on the user requirements; and (4) improve the safety of the power grid.

This illustrates the fundamental structure of the wireless charging system with a split transmitter and a split receiver in accordance with the present disclosure. It will be apparent that variants of the above-disclosed and other features and functions, or alternatives thereof, may be integrated into many other different applications. The present embodiment is, therefore, to be considered in all respects as illustrative and not restrictive. The scope of the disclosure is indicated by the appended claims rather than by the preceding description, and all changes that come within the meaning and range of equivalency of the claims are therefore intended to be embraced therein.

What is claimed is:

1. A wireless charging system for providing multi-frequency and multi-speed charging modes to transfer power wirelessly from a base device to a remote device, the wireless charging system comprising:
a split transmitter having a plurality of sub-transmitters;
a split receiver having a plurality of sub-receiver; and
a switched-capacitor circuitry comprising a plurality of switched-capacitor switches;
wherein:
the plurality of sub-receivers and the plurality of sub-transmitters each comprises co-planar induction coils of non-equal cross-sectional lengths positioned concentrically without an interception; and
the split transmitter and the switched-capacitor circuitry are controlled by a hybrid pulse width modulation (PWM) control method, and the split receiver is controlled by a model predictive control method for adaptively adjusting an output current level and a charging speed based on a status of the power grid.

2. The wireless charging system of claim 1, wherein the switched-capacitor circuitry is configured to construct a resonant circuit for charging an output load by selecting working states of the plurality of switched-capacitor switches.

3. The wireless charging system of claim 1 further comprising a switch-state control unit configured to receive or detect a time period of a peak electricity consumption and a target frequency for optimizing charging performance of the wireless charging system by controlling plural switches in the split transmitter, the split receiver, and the switched-capacitor circuitry.

4. The wireless charging system of claim 3, wherein an individual sub-transmitter of the plurality of sub-transmitters comprises a transmitter capacitor and a transmitter induction coil, thereby the plurality of sub-transmitters realize series resonant compensation networks.

5. The wireless charging system of claim 4, wherein the plurality of sub-transmitters are arranged in parallel and comprise a plurality of transmitter switches controllable by the switch-state control unit for selecting one or more transmitter induction coils to enable.

6. The wireless charging system of claim 3, wherein an individual sub-receiver of the plurality of sub-receivers comprises a receiver capacitor and a receiver induction coil for defining the output current level and the charging speed.

7. The wireless charging system of claim 6, wherein the plurality of sub-receiver are arranged in series and comprise a plurality of receiver switches controllable by the switch-state control unit for selecting one or more receiver induction coils to enable.

8. The wireless charging system of claim 3, wherein the model predictive control method determines a charging standard based on the time period of the peak electricity consumption, wherein the charging standard is selected from a slow charging mode, a normal charging mode, and a fast charging mode.

9. The wireless charging system of claim 1 further comprising an inverter at the base device, wherein the inverter comprises a plurality of switching elements, and wherein the plurality of switching elements is a field-effect transistor such as an insulated-gate bipolar transistor (IGBT), a metal-oxide-semiconductor field-effect transistor (MOSFET), or other semiconductor devices.

10. The wireless charging system of claim 1, wherein the plurality of sub-transmitters and the plurality of sub-receivers have a circular structure, a rectangular structure, or a triangular structure.

11. A wireless charging system for providing charging modes of plural charging frequencies and plural charging speeds, comprising:
a transmitter having a transmitter coil arrangement; and
a receiver having a receiver coil arrangement;
wherein:
the transmitter coil arrangement, the receiver coil arrangement, or both the transmitter coil arrangement and the receiver coil arrangement have multiple induction coils for providing the charging modes with an adjustable charging frequency and an adjustable charging speed; and
the multiple induction coils are co-planar coils concentrically arranged.

12. The wireless charging system of claim 11, wherein:
the transmitter comprises a plurality of sub-transmitters arranged in parallel; and
an individual sub-transmitter of the plurality of sub-transmitters comprises a transmitter capacitor and a transmitter induction coil for realizing series resonant compensation networks.

13. The wireless charging system of claim 11 or claim 12, wherein:
the receiver comprises a plurality of sub-receivers arranged in series; and
an individual sub-receiver of the plurality of sub-receivers comprises a receiver capacitor and a receiver induction coil for defining an output current level and a charging speed.

14. The wireless charging system of claim 11, wherein the multiple induction coils have the shape of a circle, a rectangle, or a triangle.

15. A method of wirelessly transmitting power, the method comprising the steps of:
selecting a number of sub-transmitters to be enabled and choosing a suitable resonant circuit of a switched-capacitor circuitry for charging an output load using a hybrid pulse width modulation (PWM) control method;
determining a time period of a peak electricity consumption for adaptively adjusting an output current level and a charging speed using a model predictive control method;
generating a magnetic field via a split transmitter having a plurality of sub-transmitters in response to receiving an electrical current from a power source; and
receiving the magnetic field via a split receiver having a plurality of sub-receiver placed above the split transmitter, wherein the plurality of sub-receivers and the plurality of sub-transmitters each comprises co-planar induction coils of non-equal cross-sectional lengths positioned concentrically without an interception.

16. The method of claim 15 further comprising the step of determining a charging standard selected from a slow charging mode, a normal charging mode, and a fast charging mode for achieving smart-grid integration, wherein the charging standard is changed to the slow charging mode at the time period of the peak electricity consumption.

17. The method of claim 15, wherein an individual sub-transmitter of the plurality of sub-transmitters comprises a transmitter capacitor and a transmitter induction coil, wherein the plurality of sub-transmitters are arranged in parallel and comprise a plurality of transmitter switches controllable for selecting one or more transmitter induction coils to enable.

18. The method of claim 15, wherein an individual sub-receiver of the plurality of sub-receivers comprises a receiver capacitor and a receiver induction coil, wherein the plurality of sub-receiver are arranged in series and comprise a plurality of receiver switches controllable for selecting one or more receiver induction coils to enable.

19. The method of claim 15, wherein the plurality of sub-transmitters and the plurality of sub-receivers have a circular structure, a rectangular structure, or a triangular structure.
